(19) United States
(12) Patent Application Publication
(10) Pub. No.: US 2014/0210678 A1
(43) Pub. Date: Jul. 31, 2014

(54) COMPACT DUAL BAND GNSS ANTENNA DESIGN

(71) Applicant: The Ohio State University, Columbus, OH (US)

(72) Inventors: Chi-Chih Chen, Dublin, OH (US); Ming Chen, Columbus, OH (US); Chia-wei Liu, Fremont, CA (US)

(21) Appl. No.: 13/936,955

(22) Filed: Jul. 8, 2013

Related U.S. Application Data
(60) Provisional application No. 61/668,633, filed on Jul. 6, 2012.

(51) Int. Cl. H01Q 21/30

(52) U.S. Cl. CPC H01Q 21/30
USPC 343/725

(57) ABSTRACT

An antenna structure comprising a dielectric substrate layer and a patch layer laminated on top of the dielectric substrate layer, wherein the antenna structure is adapted to provide dual band coverage by combining a patch mode and a slot mode configuration.

### CROSS-REFERENCE TO RELATED APPLICATIONS

This application claims priority to U.S. Provisional Application No. 61/668,633, filed Jul. 6, 2012, which is hereby incorporated by reference in its entirety.

### STATEMENT REGARDING FEDERALLY SPONSORED RESEARCH OR DEVELOPMENT

This invention was made with government support under contract no. FA8650-09-C-1608 awarded by Air Force SBIR Phase II. The government has certain rights in the invention.

### BACKGROUND AND SUMMARY OF THE INVENTION

Exemplary embodiments of the present invention relate generally to a novel design for a compact, slot-loaded, proximity fed patch antenna structure. While the description herein describes frequency bands that are employed in global positioning system (GPS) implementations for exemplary calculations, the design may be equally applied to other applications where a compact, dual band antenna is desirable.

Global navigation satellite systems (GNSS) such as GPS have become very commonly used devices. Well known uses include automobile and truck navigation systems and military applications. The rapid growth of GNSS technology also includes a growing list of new applications, some examples of which include: vehicle and package tracking, child monitoring, surveying, construction, sports equipment, workforce management, and farming. Along with the growth of applications, there are a growing number of GNSS systems such as GPS (U.S.), GLONASS (Russia), Galileo (Europe), and Beidou (China). Due to this growth, additional frequency bands are being allocated for GNSS use. As a result, GNSS transmitting and receiving electronics, including antennas, may be required to be configurable for a range of frequency channels. There is also an increasing amount of clustering of GNSS channels within these bands. A direct result of this clustering is the need for advanced coding schemes for the satellite signals used by GPS devices, and these advanced coding schemes frequently require wider bandwidth GNSS transmission and reception systems.

In addition to being able to receive a greater number of GNSS channels and having wider channel bandwidths, many GNSS applications require antennas to be small in size in order to fit into the desired device packaging. For example, GPS currently operates using the L1 (1575 MHz) and L2 (1227 MHz) bands. Most existing commercial small L1/L2 GNSS/GPS antennas have relatively narrow 10 MHz bandwidths that are not adequate for supporting advanced GPS coding schemes. Bowtie dipole and spiral antenna designs have been used to achieve wider bandwidth but such designs are relatively large in size and not suitable for small GPS devices. Because of the increasing number of GNSS frequency bands, requirements for wider bandwidths, and a desire for small physical sizes, there is an unmet need for a dual-band, wide bandwidth, and small in size antenna design.

Disclosed herein is an exemplary antenna structure adapted to provide dual band coverage comprising a dielectric substrate layer and a patch layer configured with slots. An embodiment is also disclosed that further comprises a 90 degree hybrid coupler in electronic communication between the patch layer and the signal source feeding the patch layer. Embodiments of the antenna are adapted to utilize both patch and slot modes to produce wide bandwidth and dual band coverage. An additional embodiment of the invention is comprised of a plurality of antennas, each comprising a dielectric substrate layer, and a patch layer configured with slots. An exemplary embodiment may also include a 90 degree hybrid coupler in electronic communication between the patch layer and the signal source feeding the patch layer.

In addition to the novel features and advantages mentioned above, other benefits will be readily apparent from the following descriptions of the drawings and exemplary embodiments.

### BRIEF DESCRIPTION OF THE DRAWINGS

FIG. 1a is a top plan view illustration of an exemplary embodiment of an antenna of the invention;

FIG. 1b is a perspective view of the embodiment of FIG. 1a.

FIG. 2a is an illustration of an exemplary embodiment of an antenna of the invention in electronic communication with a 90 degree chip hybrid coupler.

FIG. 2b is a side elevation view of the antenna of FIG. 2a.

FIG. 3 is a graph of calculated impedance with respect to frequency for an exemplary embodiment.

FIG. 4 is a graph of calculated impedance with respect to frequency for an exemplary embodiment.

FIG. 5 is a graph of calculated impedance with respect to frequency for an exemplary embodiment.

FIG. 6 is a graph of realized gain with respect to frequency for an exemplary embodiment.

FIGS. 7a and 7b are top plan view illustrations of exemplary embodiments of the invention.

FIGS. 8a-8d are graphs of peak gains of the embodiments of FIGS. 7a and 7b.

### DETAILED DESCRIPTION OF EXEMPLARY EMBODIMENT(S)

Exemplary embodiments of the present invention are directed to a compact dual band antenna design. For example, one embodiment of the antenna may be configured to be 25.4 mm in diameter and 11.27 mm in height (i.e., thickness). In one example, the size of the antenna is only about λ/10 in L2 band. Unlike known designs, exemplary embodiments of the present invention do not require stacked patch configurations and therefore, do not require an internal conducting patch. In an exemplary embodiment, dual band coverage may be achieved by operating the patch mode in L2 band and slot mode in L1 band.

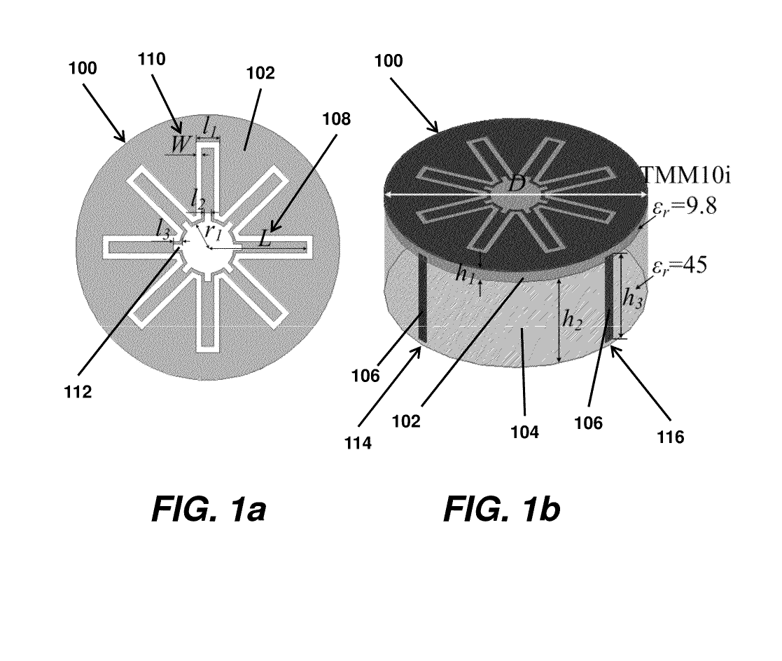

Referring to FIGS. 1a and 1b, an exemplary embodiment of an antenna 100 according to the present invention may comprise a single slot-loaded conducting patch 102 bonded to a high dielectric ceramic puck 104. In an embodiment of the invention, the slot-loaded patch design may be fabricated using a thermoset microwave laminate such as Rogers TMM10i board (h₁=1.27 mm, εᵣ=9.8, tanδ=0.002) (Rogers Corporation, One Technology Drive, Rogers Conn., USA) or another suitable board material. Such fabrication of the patch and slot structures in the laminated material may be performed using standard printed circuit board (PCB) fabrication processes. In the illustrated embodiment, the high dielectric ceramic puck 104 (h₂=10 mm, εᵣ=45, tanδ≈0.0001) may be bonded to the slot-loaded patch using ECCOSTOCK® dielectric paste (εᵣ=15) (Emerson & Coming Microwave Products, 28 York Avenue, Randolph Mass. USA or other suitable material). Using such a dielectric paste may avoid air gaps and a low-dielectric bonding layer such as formed by common glues. Avoidance of such gaps and a low-dielectric bonding layer may reduce the occurrence of detuning of resonant frequencies as these occurrences may undesirably impact the performance of the resulting antenna structure. Additionally, such an embodiment of the invention may be mechanically superior to known stacked-patch designs where the presence of a middle conducting patch may weaken the bonding between a top and bottom layers of such a design.

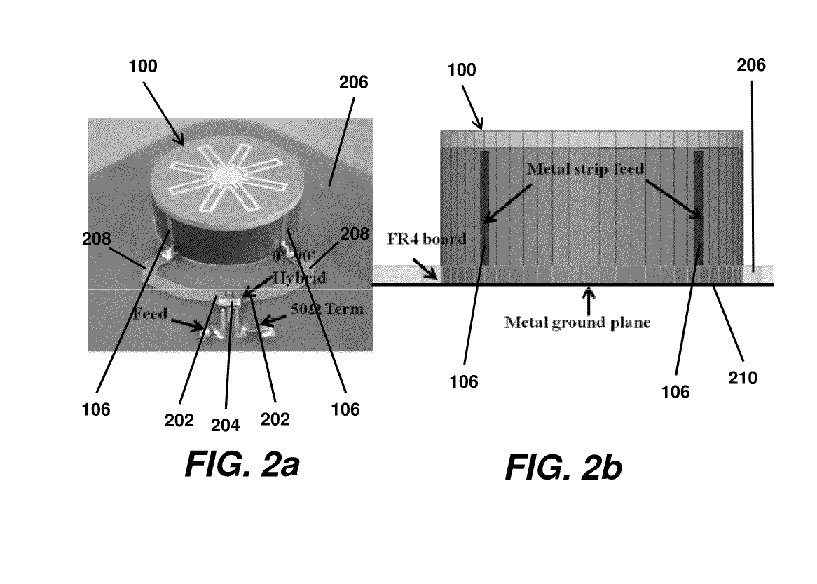

In an exemplary embodiment of the invention, at least two conducting strips may serve as proximity probes (i.e., feeds). As is illustrated in FIG. 1b, two conducting strips 106 may be vertically located on the external sides of the antenna structure. In one example embodiment of the antenna, such strips may be formed having a width of 2 mm and a height of 9.8 mm and be located between two adjacent meandering slots at 90 degrees azimuth angle from each other. Such as is illustrated in FIGS. 2a and 2b, the conducting strips 106 may be connected to the outputs 202 of a 0-90 degree hybrid circuit 204 to obtain right hand circular polarization (RHCP) of the antenna output signal.

Once upper and lower frequency bands are chosen based on the intended application, dielectric constants, the thickness of the upper and lower dielectric layers, the length and width dimensions of the meandering slots, and the length of the inner tuning stubs may be varied to achieve resonant frequencies at those upper and lower bands. An optimal design of the antenna structure illustrated in FIGS. 1a and 1b may be derived by following three steps after selecting the diameter based on physical characteristics and the two desired resonant frequencies of an application to which the antenna structure will be applied. In the first design step, the dielectric constant and thickness of the stacked dielectric material is determined according to the desired lower resonant frequency of the antenna structure. The effective dielectric constant (ε_{eff}) of a two stacked dielectric layers may be estimated using a double layer parallel plate capacitor model (Equation 1) where (ε₁, h₁), (ε₂, h₂) are the dielectric constant and thickness of top and bottom dielectric layers, respectively.

$${ɛ}_{eff} \approx \frac{{ɛ}_{1} {ɛ}_{2} ( {h}_{1} + {h}_{2} )}{{ɛ}_{1} \cdot {h}_{2} + {ɛ}_{2} \cdot {h}_{1}} \qquad Equation 1$$

The resonant frequency of the lowest mode may then be estimated from Equation 2, using the estimated ε_{eff} from Equation 1 and the chosen diameter (D).

$${f}_{0} \approx \frac{1.84}{π D \sqrt{μ {ɛ}_{eff}}} \qquad Equation 2$$

If the top dielectric layer is fabricated from thermoset microwave laminate material as disclosed above then, in practice, the dielectric constant and thickness (ε₁, h₁) of the top dielectric layer may be determined based on available printed circuit board materials. Therefore, the characteristics of the ceramic puck material used to form the bottom dielectric layer may be used to produce a patch mode resonance that is close to the desired lower frequency band. The bandwidth requirement of the application to which the antenna structure will be applied may be used to determine the total thickness (h₁+h₂) of the stacked dielectric layers.

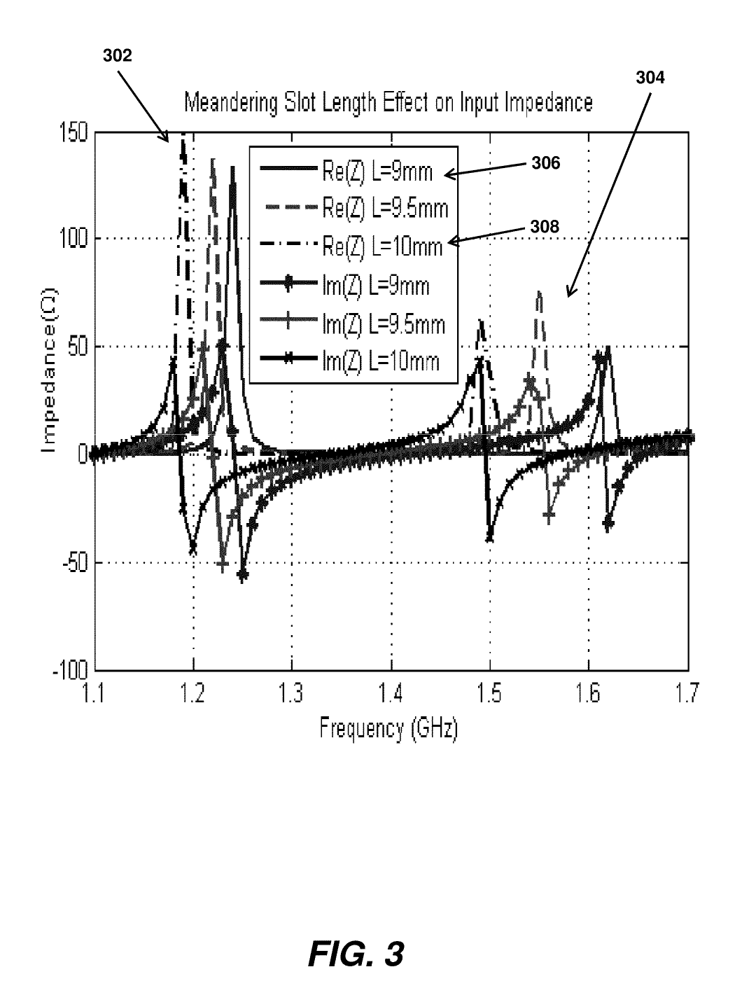

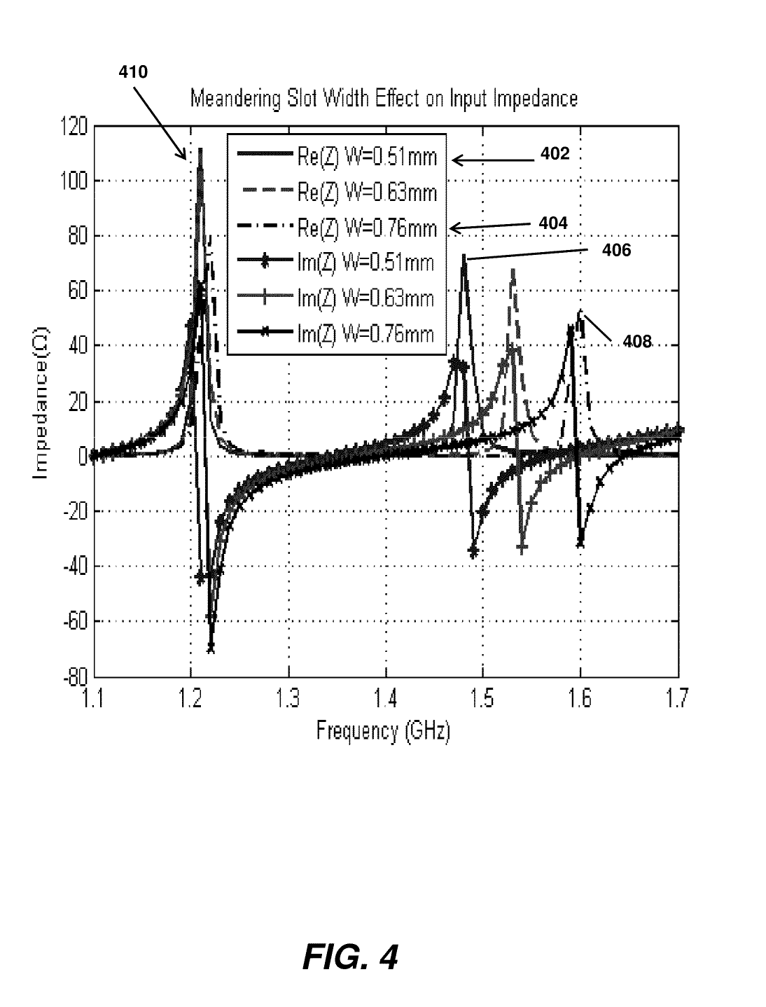

The second step is to determine the length (L) and width (W) of the meandering slots. The length is shown as 108 and the width as 110 in FIG. 1a. These dimensions may be used to tune the resonant frequency of the lower mode. As is illustrated in FIG. 3, the input impendence of an exemplary embodiment of an antenna structure is lowered as the meandering slot length 108 is increased. For example, the peak values at 302 and 304 represent calculated resonant frequency points, and increasing the slot length from 9 mm 306 to 10 mm 308 may result in a calculated lowering of both the low frequency 302 and high frequency 304 resonance points. FIG. 4 is a simulation of the change in resonant frequency as a factor of slot width. As is illustrated in the example of FIG. 4, changing the slot width from 0.51 mm 402 to 0.76 mm 404 results in a shift in the higher resonant frequency from 1.48 GHz 406 to 1.6 GHz 408 but only a slight shift in the lower resonant frequency 410.

The third step is to adjust the length of the inner tuning stubs, the outlines of which are defined by the conductive material. One such tuning stub is shown at 112 in FIG. 1a. In this example, the tuning stubs 112 extend (i.e., radiate) outward from the center hole of the patch, which is circular in an exemplary embodiment. Such as shown in the example of FIG. 1a, each of the tuning stubs 112 may extend adjacent to and/or within a proximal portion of a respective meandering slot. Other design configurations may be made in accordance with these specifications to achieve the advantages cited herein.

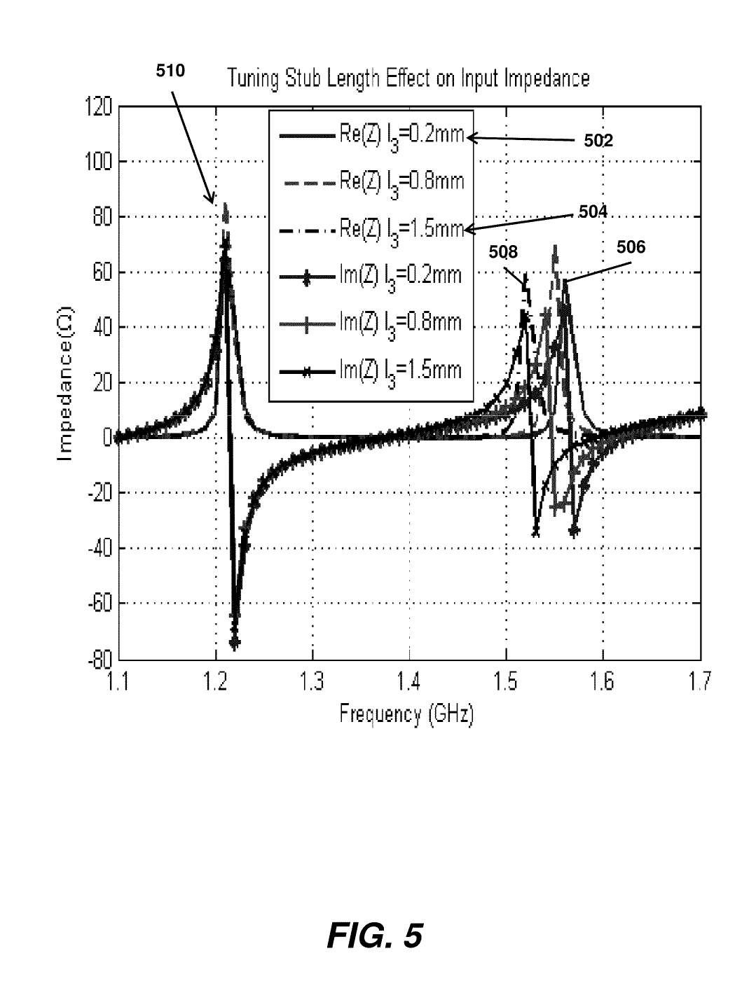

In an exemplary embodiment, a tuning slot stub may be adapted to be used for fine tuning a resonant frequency of L1 mode without affecting L2 mode. FIG. 5 illustrates the change in input impedance as the inner tuning stub length is varied in an exemplary embodiment. As is illustrated, a change in stub length from 0.2 mm 502 to 1.5 mm 504 may shift the higher resonant frequency from 1.57 GHz 506 to 1.51 GHz 508 without a significant change to the lower resonant mode 510.

An embodiment of the antenna device using the calculations and steps described above and illustrated in FIGS. 1a and 1b may utilize a 90 degree phase shift between a first and second input to the antenna structure 100. A shift of 90 degrees from a first feed 114 to a second feed 116 may be used to provide signal input to the antenna structure disclosed above. One method of achieving such a shift may be through the use of a commercially available 0-90 degree chip hybrid coupler. FIGS. 2a and 2b illustrate an example of an antenna structure mounted on a printed circuit board and placed in electrical communication with a hybrid coupler 204. A printed circuit board material (e.g., FR4 grade) is illustrated at 206. In an exemplary embodiment, the antenna structure 100 may be placed into a tightly-fit circular opening formed in the printed circuit board material. Two microstrip lines of equal length 208 are formed by a conductive layer on the top surface of the printed circuit board and may have a characteristic impedance of 50 ohms. The lines 208 may be connected to the outputs of a 0-90 degree chip hybrid coupler 204. A conductive layer 210 laminated to the printed circuit board may serve as a ground plane for the antenna structure 100 and chip hybrid coupler 204.

In one example of performance, the measured reflection coefficient was less than −20 dB from 1.1 GHz to 1.7 GHz and the transmission coefficient was approximately −3.2 dB, very close to a desired −3 dB from a half power divider, within the frequency range of interest. In this example, the measured phase difference between the two output ports varied monotonically from 88° at 1.227 GHz to 90° at 1.575 GHz, which was suitable for CP operation.

In an exemplary embodiment, when the disclosed design steps are performed to design an embodiment of the invention optimized to operate at the GPS L1 and L2 bands using Rogers TMM10i board (h₁=1.27 mm, εᵣ=9.8, tanδ=0.002) as the upper dielectric layer and a high dielectric ceramic puck (h₂=10 mm, εᵣ=45, tanδ≈0.0001) as the lower dielectric layer, the resultant design parameters are as summarized in Table 1.

TABLE 1

| Parameters | Value (mm) | Parameters | Value (mm) |
|---|---|---|---|
| L | 9.52 | r₁ | 2.5 |
| W | 0.58 | h₁ | 1.27 |
| l₁ | 2.29 | h₂ | 10 |
| l₂ | 0.61 | h₃ | 9.8 |
| l₃ | 1.02 | | |

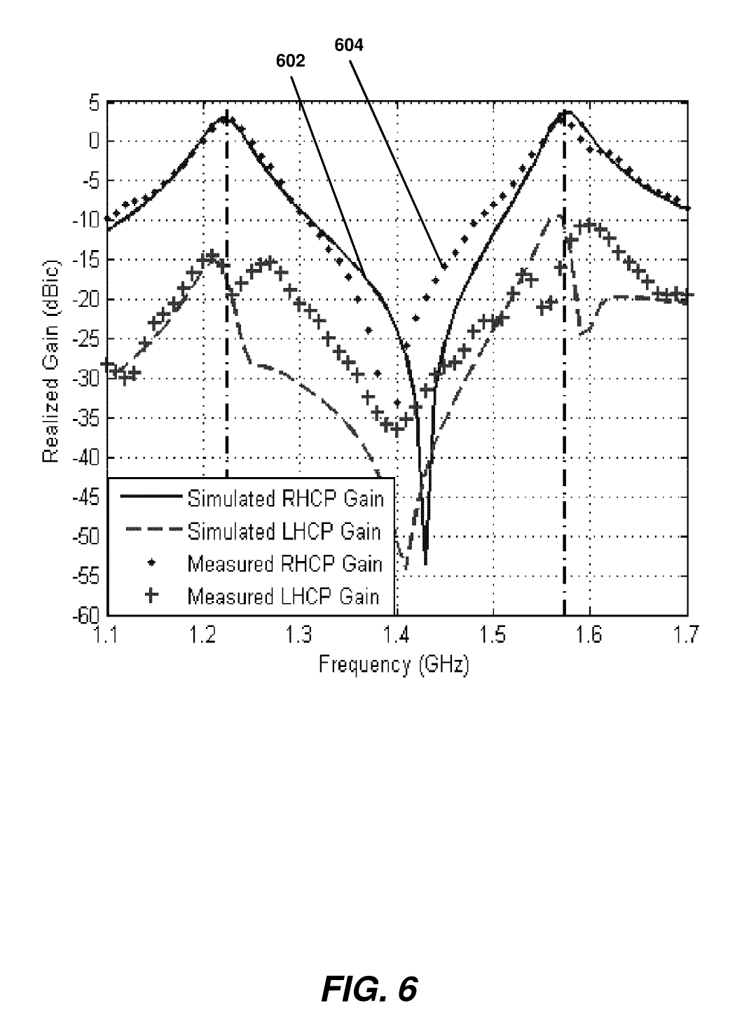

Other parameters may be obtained with the choice a different dielectric substrate. As is illustrated in FIG. 6, the simulated RHCP gain 602 of an exemplary embodiment is very close to the measured gain 604 of an antenna device constructed according to the parameters in Table 1. In this example, the RHCP antenna gain is around 3.2 dBi at 1.227 GHz and 3.5 dBi at 1.575 GHz. The RHCP to LHCP isolation is 20 dB at L2 band and 15 dB at L1 band. The axial ratio of this exemplary embodiment is 1.3 dB at 1.227 GHz and 1.9 dB at 1.575 GHz, and the 3-dB bandwidth of lower mode is 45 MHz from 1200 MHz to 1245 MHz and high mode is 50 MHz from 1545 MHz to 1595 MHz at zenith. Such bandwidths are sufficient to support modern coding schemes such as P/Y and M code.

In an exemplary embodiment, the resonant field distribution may occupy substantially the entire substrate in L2 (1227 MHz) mode and be mostly concentrated around the meandered slots in L1 (1575 MHz) mode. The meandered slots, the center circular hole of the patch, and the high dielectric substrate may help to establish L2 mode resonance within a physically small antenna volume. The concentration of fields only around slots in L1 band may also make it possible to tune the L1 frequency independently by adjusting the length I₃ of the inner tuning slot stubs.

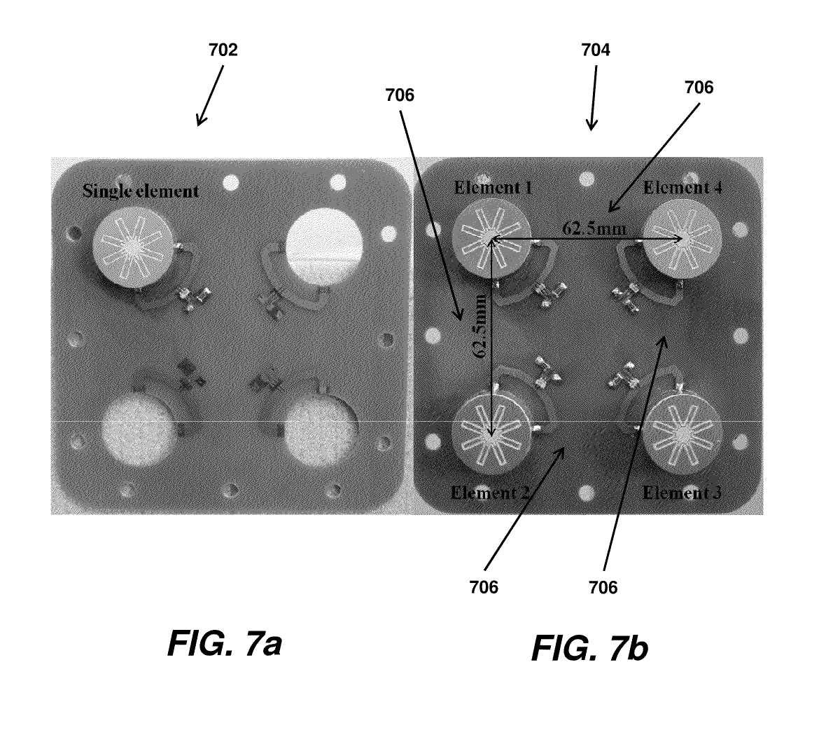

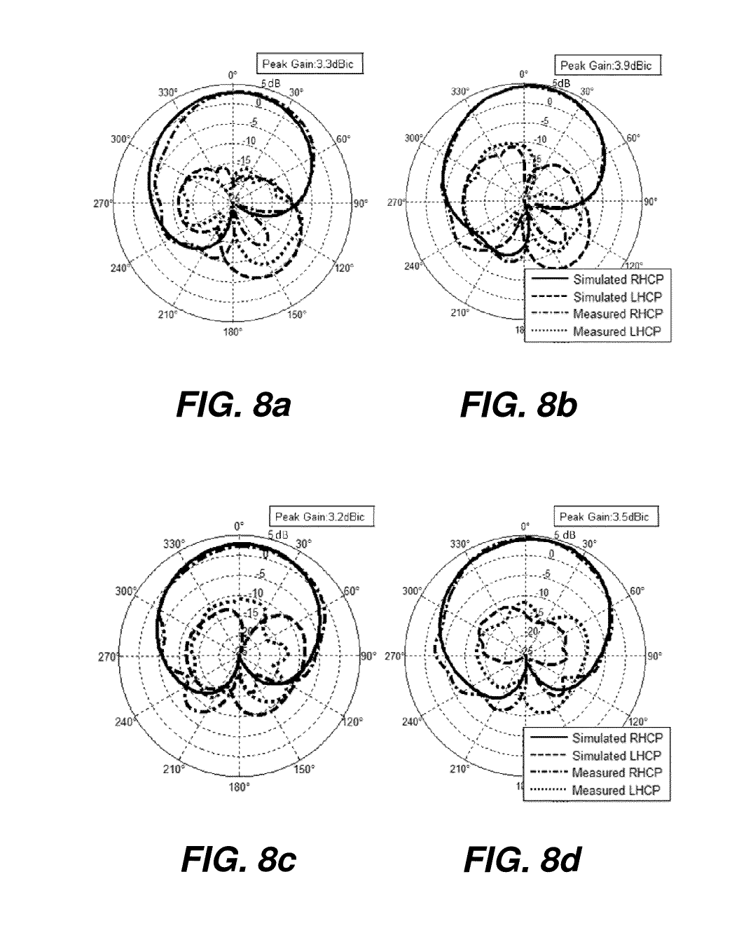

A known difficulty with closely space antenna array elements is the impact that such an array may have on the impedance matching, resonant frequency, and radiation pattern of elements of the array. Exemplary embodiments of the invention have been found to exhibit minimal impact when arranged in a compact array configuration (e.g., a compact 4-element array configuration). FIG. 7a illustrates a single antenna element 702, and FIG. 7b illustrates a multiple antenna element 704 configuration with a spacing 706 of 62.5 mm between adjacent antenna elements. Signals were introduced to the single element 702 and multiple element 704 configurations at center frequencies of the GPS L1 and L2 bands. As is illustrated in the elevation patterns of FIGS. 8a, 8b, 8c, and 8d, operating a single element in a multiple element configuration 704 with the remaining three elements terminated with 50 ohm loads (FIGS. 8a and 8b) provides a similar sky coverage and broadside gain result to that of a single element configuration 702 (FIGS. 8c and 8d). As is illustrated, the maximum gain level for the multiple element configuration 704 is 3.3 dBi at the L2 band and 3.9 dBi at the L1 band for this exemplary embodiment. These gain levels are similar to the single element gain illustrated in the example of FIGS. 8c and 8d.

In one example, an embodiment of an array configuration was designed for operation at 1.227 GHz with 45 MHz 3-dB bandwidth and 1.575 GHz with 50 MHz 3-dB bandwidth at zenith. Such an example may be miniaturized down to 25.4 mm in diameter without the feeding network and approximately 25.4 mm by 40.6 mm with the feeding network. Simulation of such an example has resulted in an indication that 90% radiation efficiency may be achieved using low loss dielectric material. In another exemplary embodiment, RHCP feeding circuitry may be implemented using a small 0°-90° hybrid chip that provides desired power splitting and stable quadrature phase difference at its two outputs. The measured gain and pattern data of such an embodiment validated the simulated performance and showed wide RHCP sky coverage and more than 15 dB of RHCP to left hand circular polarization (LHCP) isolation at both L1 and L2 bands. Other embodiments are possible based on the teaching provided herein. For example, some embodiments may have a diameter less than about 25.4 mm (i.e., 1 inch) and/or a height less than about 11.27 mm. Other embodiments may have greater dimensions.

Such as described, exemplary embodiments may employ a low-loss, high-dielectric substrate and the meandered-slot designs to increase the antenna's electrical size. An example of the design may also adopt external proximity probes. In an exemplary embodiment, the patch mode and the slot mode may share the probe(s). The combination of the above features greatly improves manufacturability and reliability. In addition, an example of the design may utilize a small 0°-90° hybrid chip (e.g., Mini-circuit QCN-19) to reduce the size of feeding network and achieve good RHCP performance over a wider frequency range. In one example, the antenna may be adapted to provide RHCP by combining two orthogonal modes via the hybrid chip. As a further example, the antenna design may be applied in an array (e.g., 4 elements) without suffering performance degradation due to mutual coupling. For example, in one such an embodiment, the antennas may have separate connectors such that one can combine received signals (digitally in post processing) using different algorithms to improve received signal quality and/or to suppress interference.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. An antenna comprising:
a dielectric substrate layer; and
a patch layer on top of said substrate layer;
wherein said antenna is adapted to provide dual band coverage with a patch mode and a slot mode.

2. The antenna of claim 1 wherein said antenna has a diameter of about 25.4 mm.

3. The antenna of claim 1 wherein said antenna has a diameter less than about one inch.

4. The antenna of claim 1 wherein said antenna has height of about 11.27 mm.

5. The antenna of claim 1 wherein said patch layer has height of about 1.27 mm.

6. The antenna of claim 1 wherein said dielectric substrate layer has a height of about 10 mm.

7. The antenna of claim 1 wherein said antenna has a dimension of about λ/10 at L2 band.

8. The antenna of claim 1 wherein said antenna is adapted to provide said patch mode at L2 band and said slot mode at L1 band.

9. The antenna of claim 1 wherein said patch layer is comprised of PCB.

10. The antenna of claim 9 wherein said patch layer further comprises a meandering slot defined by a conductive patch on top of said PCB.

11. The antenna of claim 10 wherein said conductive patch further defines a circular hole such that said dielectric substrate, said meandering slot, and said circular hole are adapted to facilitate L2 mode resonance.

12. The antenna of claim 10 wherein resonant field distribution is adapted to occupy substantially the entire dielectric substrate in L2 mode and be mostly concentrated around the meandered slot in L1 mode.

13. The antenna of claim 10 further comprising a tuning slot stub extending with said meandering slot and adapted to be used for fine tuning a resonant frequency of L1 mode without affecting L2 mode.

14. The antenna of claim 1 wherein said dielectric substrate layer has a dielectric constant of about 45.

15. The antenna of claim 1 wherein said dielectric substrate layer is adhered to said patch layer by a dielectric paste.

16. The antenna of claim 1 wherein said antenna is adapted to provide sufficient bandwidth for L1 and L2 bands with RHCP and LHCP isolation of greater than about 15 dB.

17. The antenna of claim 1 further comprising two external proximity probes such that said patch mode and said slot mode share said probes.

18. The antenna of claim 1 further comprising a 0°-90° hybrid chip.

19. The antenna of claim 18 wherein said antenna is adapted to provide RHCP by combining two orthogonal modes via said hybrid chip.

20. The antenna of claim 18 further comprising two external, vertical probes comprised of conductive material and in communication with said hybrid chip.

21. An antenna system comprising:
a plurality of antennas, each antenna comprising:
a dielectric substrate layer; and
a patch layer on top of said substrate layer;
wherein said antenna is adapted to provide dual band coverage with a patch mode and a slot mode; and
a 90° hybrid coupler in communication with at least one of said antennas.

22. The antenna system of claim 21 comprising four said antennas.

23. The antenna system of claim 21 wherein said antenna system is adapted to provide a reflection coefficient less than about −20 dB and a transmission coefficient of about −3.2 dB at a predetermined frequency.

24. The antenna system of claim 21 wherein said antenna system is adapted to provide a phase difference of about 90° in both L1 and L2 bands.
